(19) United States
(12) Patent Application Publication
(10) Pub. No.: US 2008/0296034 A1
(43) Pub. Date: Dec. 4, 2008

(54) Percussion Mechanism with a Striking Pin and an Associated Catching Mechanism

(76) Inventor: Willy Braun, Neustetten (DE)

Correspondence Address: MICHAEL J. STRIKER, 103 EAST NECK ROAD, HUNTINGTON, NY, 11743, US

(21) Appl. No.: 12/094,666

(22) PCT Filed: Apr. 19, 2007
(86) PCT No.: PCT/EP07/53824

§ 371 Date: May 22, 2008

(30) Foreign Application Priority Data
Jun. 6, 2006 (DE) 102006026158.5

(51) Int. Cl. B25D 17/00; B25D 17/08

(52) U.S. Cl. 173/4; 173/90

(57) ABSTRACT

The invention relates to a percussion mechanism (1) of a machine tool, in particular a hand-held machine tool, with a percussive pin (5), which has a region (11) of maximal diameter to which at least one catching mechanism (28) is assigned. It is provided that the catching mechanism (28) impinges on a section (15) of the percussive pin (5), which has a smaller diameter than the region (11).

The present invention relates to a percussion mechanism of a machine tool, in particular a hand-held machine tool, with a striking pin that has a region of maximum diameter and is assigned to the at least one catching mechanism.

### RELATED ART

A percussion mechanism of a hand-held power tool is known. To transfer an impact impulse to a tool, the percussion mechanism includes a striking pin (also referred to as a beatpiece) that is supported such that it is axially displaceable, which is acted upon in the striking direction with impacts on the drive side by a beater of the percussion mechanism. The tool and beater are located on opposite sides of the striking pin. A catching mechanism is assigned to the striking pin in order to releasably fix the striking pin in a certain axial position. The catching mechanism may fix the striking pin, e.g., in a position on the tool-side end of the percussion mechanism, the “neutral” position. To this end, the catching mechanism acts on a region of maximum diameter (main diameter) of the striking pin. This configuration of the catching mechanism limits the size of the striking pin, however, since the radial expansion of the striking pin is limited by the catching mechanism at its main diameter. For this reason, only striking pins with relatively small mass may be realized using a catching mechanism located in this manner.

### DISCLOSURE OF THE INVENTION

### Technical Object

The object of the present invention is to realize a catching mechanism that limits the sizing of the striking pin only minimally.

### Technical Solution

To attain this object, it is provided that the catching mechanism acts on a section of the striking pin that has a smaller diameter than the region. Sections of this type are already provided in many designs of striking pins. With these striking pins, next to the region with the maximum diameter (main diameter), there is at least one section with a smaller diameter. A transition region between the region and the section has a shoulder, with which a working position of the striking pin is specified for a striking operation. By “displacing” the impact point of the catching mechanism from the region of the main diameter to the section with the smaller diameter, the striking pin may be designed much larger in size in the region. As a result, a larger mass may be selected for the striking pin.

### ADVANTAGEOUS EFFECTS

It is provided, in particular, that the catching mechanism releasably fixes the striking pin in a neutral position. The striking pin is located on the longitudinal axis of the percussion mechanism between a beater and a tool, the beater being driven by a piston via an air cushion. The transfer of force via the air cushion to the beater may be interrupted via neutral openings in the hammer tube, which guides the air cushion. The opening and closing of the neutral openings is controlled by the striking pin and/or the beater. A tool-side position of the striking pin is assigned to the open neutral openings. This position is the neutral position of the striking pin. This position also allows the beater to assume a position on the tool side. In this position, and when neutral control is used, the beater does not cover the neutral openings, and they are “open”. As an alternative, the neutral openings may also be controlled by striking pin or beater through a neutral sleeve. The air cushion is connected with the surroundings via the open neutral openings, and the beater is no longer driven. To fix the striking pin in place after displacement into the neutral position, and to prevent the striking pin from rebounding in an uncontrolled manner, the striking pin is held by the catching mechanism.

According to a refinement of the present invention, it is provided that the catching mechanism acts on the section via a form-fit or frictional connection. To this end, the striking pin has a structure in this section on which the catching mechanism may act. In particular, the catching mechanism is a catching mechanism that encloses the section of the striking pin radially.

It is further provided that the section includes a radial groove and/or a radial projection, in particular an annular strip, for the form-fit connection. This radial groove or this radial projection may engage behind, e.g., a structure of the catching mechanism. The radial groove is a radially (circumferentially) extending groove, and the radial projection is a projection that extends in an axial section. It is also possible to locate several radial projections in an axial section in the circumferential direction. The annular strip is a strip-like structure that extends circumferentially and radially.

In particular, it is provided that the catching mechanism is designed as a catching ring. A flexible ring may enter into a form-fit and/or frictional connection with the radial projection of the section and thereby fix the striking pin in the desired position (e.g., the neutral position). In a position of the striking pin that does not correspond to this fixing position, the striking pin may be moved through the catching ring without interacting with it. An elastic catching ring of this type may snap, e.g., into a suitably designed annular groove or a projection in the section of the striking pin and releasably fix the striking pin in position.

It is further provided that the catching mechanism is composed essentially of an elastomeric material.

According to a refinement of the present invention, it is provided that the percussion mechanism includes a damping device for damping the motion of the striking pin in an end position, the catching mechanism being integrated in the damping device. The damping device may be designed, e.g., as an annular damping shoulder, in whose damping material the catching mechanism is embedded.

In particular, it is provided that the damping device is designed as a B-impact damping device or as a neutral damping device. The neutral damping device is located on the tool-side end of the striking bolt guide and ensures that the striking pin—in its end striking position—is damped as much as possible and is not reflected. The B-impact damping mechanism (return damping mechanism) of the striking pin is a damping mechanism installed on the beater-side end of the striking bolt guide, which dampens the striking pin in the working position when it is reflected back by the tool, so that it is not reflected back and remains in the working position. Both damping mechanisms act on a shoulder of the striking pin located in a transition region between the region with the main diameter (maximum diameter) and at least one section with a smaller diameter.

According to a refinement of the present invention, it is provided that the damping mechanism includes the catching mechanism, in particular via the formation of an annular inner shoulder. With this design, the catching mechanism is part of the damping mechanism. The elastic material used to dampen the impulse of the striking pin is designed at least one point with an inner shoulder with an annular design, thereby performing the task of the elastic catching ring.

It is further provided that the damping device includes a damping ring, which forms the catching ring.

Finally, it is provided that the striking pin includes at least one radially extending, elastic projection, which may engage in a recess of the striking pin guide in the catching position. A supplementary catching mechanism of this type also prevents the striking pin from rebounding, in one of the end positions of the striking pin in particular. The elastic projection may be formed, e.g., by an O ring, which lies in an annular groove of the striking pin. This O ring may serve as a sealing ring to seal off the percussion mechanism.

### BRIEF DESCRIPTION OF THE DRAWING

The present invention is explained with reference to the figures, as follows:

FIG. 1 shows a non-inventive percussion mechanism with a striking pin and a catching mechanism assigned to the striking pin,

FIGS. 2A and 2B show an inventive percussion mechanism with a striking pin and an assigned catching mechanism, according to the first exemplary embodiment,

FIGS. 3A and 3B show an inventive percussion mechanism with a striking pin and an assigned catching mechanism, according to a second exemplary embodiment,

FIGS. 4A and 4B show an inventive percussion mechanism with a striking pin and an assigned catching mechanism, according to a third exemplary embodiment, and

FIGS. 5A and 5B show an inventive percussion mechanism with a striking pin and an assigned catching mechanism, according to a fourth exemplary embodiment.

### EMBODIMENT(S) OF THE INVENTION

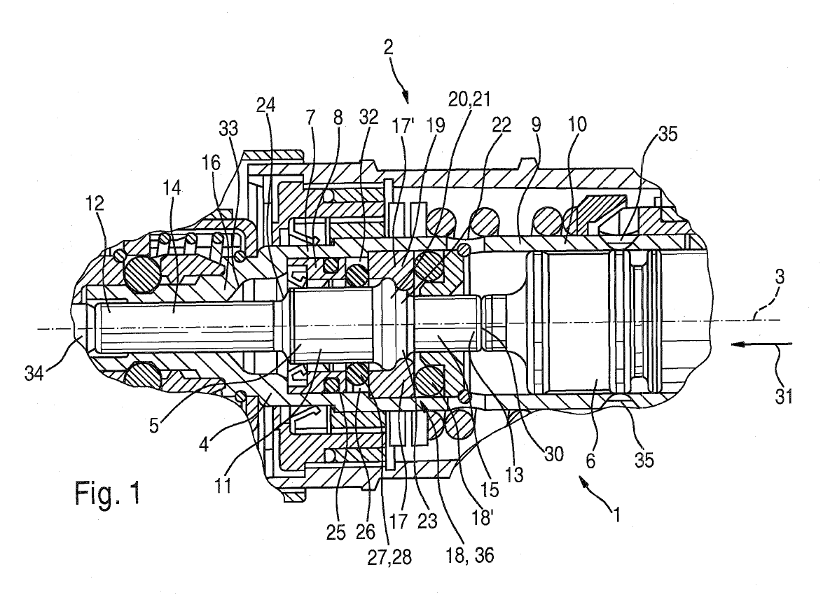

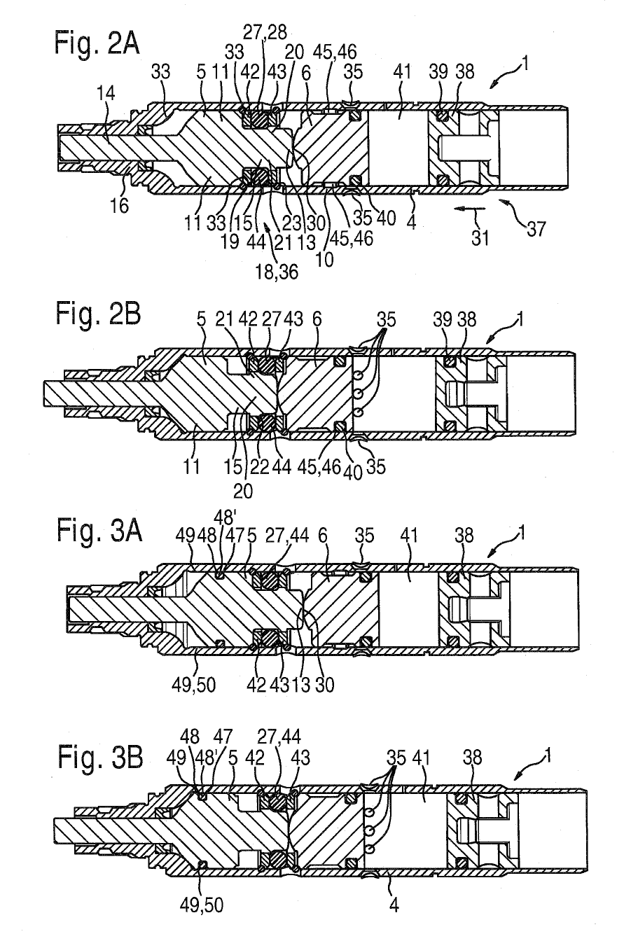

FIG. 1 shows a non-inventive percussion mechanism 1 of a machine tool. Non-inventive percussion mechanism 1 will be described below only in the scope in which the inventive embodiments of percussion mechanism 1 are presented in FIGS. 2A through 5B.

The part of percussion mechanism 1 shown in FIG. 1 includes a hammer tube 4 in its central percussion mechanism region 2 that extends along a longitudinal axis 3. A striking pin 5 and a beater 6, which are located one behind the other along a line, are located inside hammer tube 4. Part 7 of hammer tube 4 that encloses striking pin 5 is designed as a striking pin guide 8. Part 9 of hammer tube 4 that encloses beater 6 is designed as a beater guide 10. Striking pin 5 includes a central region 11 with a maximum diameter (main diameter), which is bounded by two sections 14, 15 at both ends 12, 13 of striking pin 5, the two sections 14, 15 having a smaller diameter than region 11. Striking pin guide 8 includes two tapered guide regions 16, 17. Second guide region 17 is formed, at least partially, by a stop ring 17′, which is designed as a steel ring with a contact shoulder 19. Stop ring 17′ forms—together with an O ring 18′—a damping device 18. O ring 18′ is composed of a material that dampens the return of striking pin 5. Region 11 of striking pin 5 includes a radial projection 20 designed as annular strip 21 on its section 15. Annular strip 21 transitions—on its side 22 facing the beater—into an annular shoulder 23 located between region 11 and section 15. A further annular shoulder 24 is located between region 11 and section 14. In a central axial section 25 of striking pin guide 8, there is a catching mechanism 28 designed as an elastic catching ring 27 in an annular groove 26 for releasably fixing striking pin 5 in a position that faces away from beater 6 and is not shown here (the neutral position).

The following function of catching mechanism 28 inside percussion mechanism 1 results: Beater 6, which is set into a reciprocating motion by a not-shown drive, strikes—with its end face 30—end 13 of striking pin 5 when it moves forward (arrow 31), thereby imparting an impulse to it. Driven by this impact, striking pin 5 moves in the direction of impact (arrow 31), and annular strip 21 “dives through” elastic catching ring 27. This is possible, since catching ring 27 is composed, e.g., of elastomeric material, and may move outwardly into an outer region 32 of annular groove 26. When annular shoulder 24 reaches a region of contact shoulder 33 of striking pin guide 8, striking pin 5 has reached its neutral position. If striking pin 5 did not previously transfer its impulse to a tool element 34 located in front of end 12 of striking pin 5, annular shoulder 24 strikes contact shoulder 33, and striking pin 5 will rebound against the direction of the impact (arrow 31). This rebound may be damped more or less strongly, depending on the damping capacity of contact shoulder 33. When rebound occurs, annular strip 21 strikes catching ring 27 once more. Catching ring 27 catches annular strip 21 with a form-fit and/or frictional connection and holds it in the neutral position, provided the return (rebound) is not too great. The result is that catching ring 27 reaches behind side 22 facing end 13. Via the releasable fixing of striking pin 5 in the neutral position, beater 6 may also be moved into its neutral position, which is shifted forward in the direction of tool element 34, so that end face 30 bears against end 13. The beater releases neutral openings 35 in hammer tube 4. Damping device 18 is designed as B-impact damping device 36, which dampens the rebound of the striking pin.

FIGS. 2A, 3A, 4A, and 5A show four different embodiments of inventive percussion mechanism 1, with striking pin 5 and beater 6 in their working positions. FIGS. 2B, 3B, 4B, and 5B show the related embodiments, with striking pin 5 and beater 6 in their neutral positions. The design of inventive percussion mechanism 1 essentially corresponds to the design of percussion mechanism 1 shown in FIG. 1, so only the differences will be discussed here.

FIGS. 2A through 5B show drive 37 of beater 6 on the end of hammer tube 4. Beater 6 is composed of a piston 38, which is driven by a not-shown motor, with a sealing ring 39, which sets the beater 6 with sealing ring 40 into a reciprocating motion using an air cushion 41 located between beater 6 and piston 38. If beater 6 and striking pin 5 are in the neutral position (FIGS. 2B, 3B, 4B, 5B), beater 6 releases neutral openings 35, which results in pressure equalization of air cushion 41 with the surroundings when in the neutral position. When the hand-held power tool is pressed by an operator via a not-shown tool (with tool element 34) against a not-shown work piece, striking pin 5 is moved from the neutral position shown in FIGS. 2B, 3B, 4B, 5B and into the working position shown in FIGS. 2A, 3A, 4A, 5A, in which striking pin 5 and beater 6 are displaced in the direction of piston 38 so far that annular shoulder 23 of the striking pin bears against damping device 18, which is designed as contact shoulder 19, so that the beater, which is located behind striking pin 5, completely covers neutral openings 35. In this working position, piston 38 may build up pressure in air cushion 41 in order to set beater 6 into a forward motion (arrow 31), that is, so that beater 6 may strike—via its end face 30—end 13 of the striking pin in order to transfer an impulse to it.

In the exemplary embodiments shown in FIGS. 2A, 2B, 3A, and 3B, percussion mechanism 1 includes a catching mechanism 28 designed as catching ring 27, which acts on a projection 20 designed as annular strip 21 in section 15 of striking pin 5. To this end, catching ring 27 is integrated in damping device 18. Via this “displacement” of catching device 28 in one of the guide sections 16, 17, the maximum diameter of striking pin 5 (main diameter) in region 11 may be selected largely freely, since it is not limited by the size of catching mechanism 28, which is designed as catching ring 27. Damping device 18, which is designed as B-impact damping device 36, is composed of two stop disks 42, 43, between which damping ring 44 designed as catching ring 27 is located. Damping ring 44 may reach behind annular shoulder 23 of annular strip 21 and releasably fix striking pin 5 in place in the neutral position. In terms of its functions, damping ring 44 corresponds to catching ring 27 and O ring 18′ of the percussion mechanism in FIG. 1. As support for fixing striking pin 5 in position, beater guide 10 may include an annular groove 46 designed as a turned recess 45, in which sealing ring 40 may snap into place and hold beater 6 in its front end position (neutral position).

FIGS. 3A and 3B show an additional retaining mechanism that uses a preloaded O ring 48′ placed in an annular groove 47 of striking pin 5, which may snap into place in recess 50—designed as a turned recess 49—in striking pin guide 8 and prevent striking pin 5 from rebounding. O ring 48′ forms an elastic projection 48 and performs a sealing function. This additional retaining mechanism may be used as a supplement.

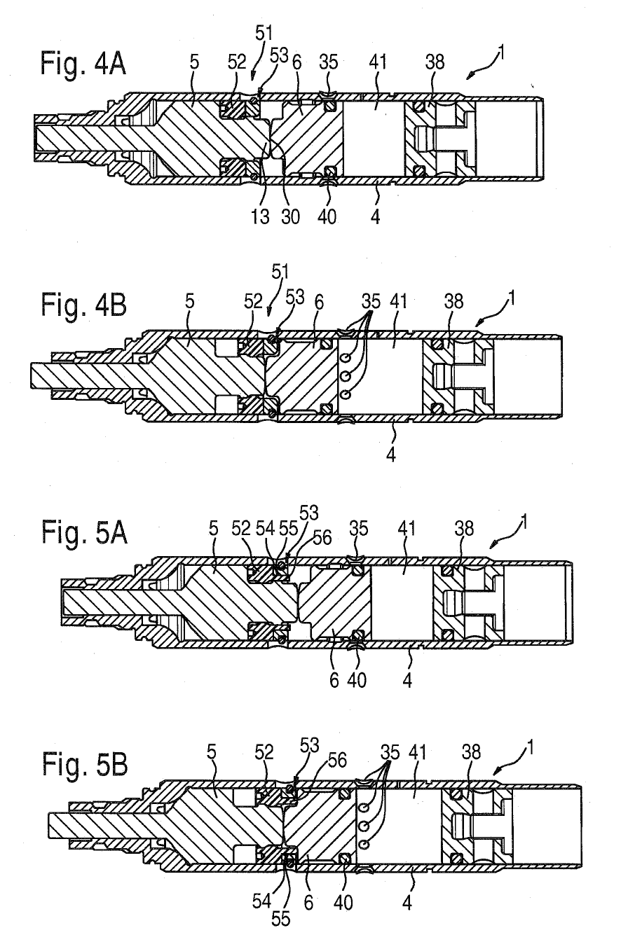

As an alternative to the use of damping ring 44 shown in FIGS. 2 and 3 as catching ring 27, FIGS. 4 and 5 show a specially-formed impact-damping unit 51 that has specific damping and catching properties due to its shape. Since impact-damping unit 51 does not include stop disk 42 on the striking pin side, impact-damping unit 51 may be shorter in design than the embodiment with stop disks 42, 43 and damping ring 44. In the simplest case, impact-damping unit 51 is designed as two pieces. An elastomeric part 52 is fixedly connected with a steel ring 53. The connection may be established via vulcanizing or form-fit clamping or staking. Steel ring 53 includes continuous grooves 55 on its inner circumference 54, through which at least one projection 56 of elastomeric part 52 may extend through to beater 6, when beater 6 is in the neutral position. The projection—as the buffer—may brake beater 6 shortly before it reaches its front end position (neutral position), thereby making it possible to prevent a strong rebound of beater 6.

What is claimed is:

1. A percussion mechanism of a machine tool, in particular a hand-held power tool, with a striking pin, which has a region of maximum diameter to which at least one catching mechanism is assigned,
wherein
the catching mechanism (28) acts on a section (14, 15) of the striking pin (5) that has a smaller diameter than the region (11).

2. The percussion mechanism as recited in claim 1,
wherein
the catching mechanism (28) releasably fixes the striking pin (5) in a neutral position.

3. The percussion mechanism as recited in claim 1,
wherein
the catching mechanism (28) acts on the section (14, 15) via a form-fit and/or frictional connection.

4. The percussion mechanism as recited in claim 1,
wherein
the section (14, 15) includes a radial groove and/or a radial projection (20), in particular an annular strip (21) for the form-fit connection.

5. The percussion mechanism as recited in claim 1,
wherein
the catching mechanism (28) is designed as a catching ring (27).

6. The percussion mechanism as recited in claim 1,
wherein
the catching mechanism (28) is composed essentially of an elastomeric material.

7. The percussion mechanism as recited in claim 1, characterized by at least one damping device (18) for damping the motion of the striking pin in an end position, the catching mechanism (28) being integrated in the damping device (18).

8. The percussion mechanism as recited in claim 1,
wherein
the damping device (18) is designed as a B-impact damping device (36) or a neutral damping device.

9. The percussion mechanism as recited in claim 1, characterized by a striking pin guide (8) that includes the damping device (18).

10. The percussion mechanism as recited in claim 1
wherein
the damping device (18) includes the catching mechanism (28), in particular via the formation of an annular inner shoulder.

11. The percussion mechanism as recited in claim 1,
wherein
the damping device (18) includes a damping ring (44), which serves as the catching ring (27).

12. The percussion mechanism as recited in claim 1,
wherein
the striking pin (5) includes at least one radially extending, elastic projection (48), which may engage in a recess (50) of the striking pin guide (8).
